(19) United States
(12) Patent Application Publication
(10) Pub. No.: US 2016/0167689 A1
(43) Pub. Date: Jun. 16, 2016

(54) Shopping Bag Apparatus

(71) Applicant: Michael Haynes, Altadena, CA (US)

(72) Inventor: Michael Haynes, Altadena, CA (US)

(21) Appl. No.: 14/569,530

(22) Filed: Dec. 12, 2014

(51) Int. Cl. B62B 3/14; A45C 3/00; A45C 3/04; B65D 33/10; B65D 33/28

(52) U.S. Cl. CPC B62B 3/1464; B65D 33/105; B65D 33/28; A45C 3/04; A45C 3/001

(57) ABSTRACT

A shopping bag apparatus that integrates with a shopping basket and a shopping cart is presented. The shopping bag comprises a rectangular bottom wall, and a plurality of side walls attached to the bottom wall in a substantially perpendicular configuration to define a volume of space above the bottom wall and an edge with four corners at the top. The plurality of side walls comprises a first side wall coupled to a left side of said bottom wall, a second side wall coupled to a back side of said bottom wall, a third side wall coupled to a right side of said bottom wall, and a fourth side wall coupled to a front side of said bottom wall. The shopping bag further comprises a band at the top edge configured to secure the edge around a lip of a shopping basket. The shopping bag further includes a pair of handles attached to the first and third side walls, a pair of carrying straps attached to the second and fourth side walls, and a plurality of fasteners with at least one fastener coupled to each of said four corners for removably coupling the shopping bag to a shopping cart.

### BACKGROUND OF THE INVENTION

1. Field of the Invention

Embodiments of the invention relates to the field of portable flexible containers. More specifically, the invention relates to a shopping bag apparatus.

2. Description of the Related Art

Most jurisdictions in the United States have enacted or are enacting laws that require shoppers to either bring their own shopping bags or purchase a reusable bag from the retail establishment. Currently available shopping bags do not removably integrate with the shopping cart and/or a shopping basket thus complicating and limiting the shopping experience.

### BRIEF SUMMARY OF THE INVENTION

One or more embodiments of the invention are directed to a shopping bag apparatus that is couplable to a retail shopping apparatus, e.g. shopping cart or shopping basket, to ease the retail shopping experience. The shopping bag apparatus integrates with a shopping basket and a shopping cart. The shopping bag is preferably made of durable and flexible fabric material. In one or more embodiments, the fabric is also waterproof thus possibly providing a germ barrier between the dirty shopping cart or basket and the items placed in the shopping bag.

In one or more embodiments, the shopping bag comprises a rectangular bottom wall, and a plurality of side walls attached to the bottom wall in a substantially perpendicular configuration to define a volume of space above the bottom wall and an edge with four corners at the top. The plurality of side walls comprises a first side wall coupled to a left side of said bottom wall, a second side wall coupled to a back side of said bottom wall, a third side wall coupled to a right side of said bottom wall, and a fourth side wall coupled to a front side of said bottom wall.

One or more embodiments of the shopping bag further comprise a band at the top edge configured to secure the edge around a lip of a shopping basket. The band may be elastic or other material. The bang may include a locking mechanism for tightening the top edge around the shopping basket.

One or more embodiments of the shopping bag further includes a pair of handles attached to the first and third side walls, a pair of carrying straps attached to the second and fourth side walls, and a plurality of fasteners with at least one fastener coupled to each of said four corners for removably coupling the shopping bag to a shopping cart.

### BRIEF DESCRIPTION OF THE DRAWINGS

The above and other aspects, features and advantages of the invention will be more apparent from the following more particular description thereof, presented in conjunction with the following drawings wherein:

FIG. 1 is an illustration of a front-side perspective view of the shopping bag in an inside-out configuration in accordance with one or more embodiments of the present invention.

FIG. 2 is an illustration of a side view of the shopping bag in an inside-out configuration in accordance with one or more embodiments of the present invention.

FIG. 3 is an exploded view illustrating a side handle of the shopping bag in an inside-out configuration in accordance with one or more embodiments of the present invention.

FIG. 4 is an illustration of a top perspective view of the shopping bag in a normal configuration and coupled to a shopping cart in accordance with one or more embodiments of the present invention.

FIG. 5 is an illustration of a top-side view of the shopping bag in a normal configuration and coupled to a shopping cart in accordance with one or more embodiments of the present invention.

FIG. 6 is an exploded view illustrating a hook for coupling the shopping bag to a shopping cart in accordance with one or more embodiments of the present invention.

FIG. 7 is an illustration of the shopping bag coupled to a shopping basket with the shopping bag providing the handles in accordance with one or more embodiments of the present invention.

FIG. 8 is an illustration of the shopping bag coupled to a shopping basket with the shopping basket providing the handles in accordance with one or more embodiments of the present invention.

### DETAILED DESCRIPTION

The present invention comprising a shopping bag apparatus will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

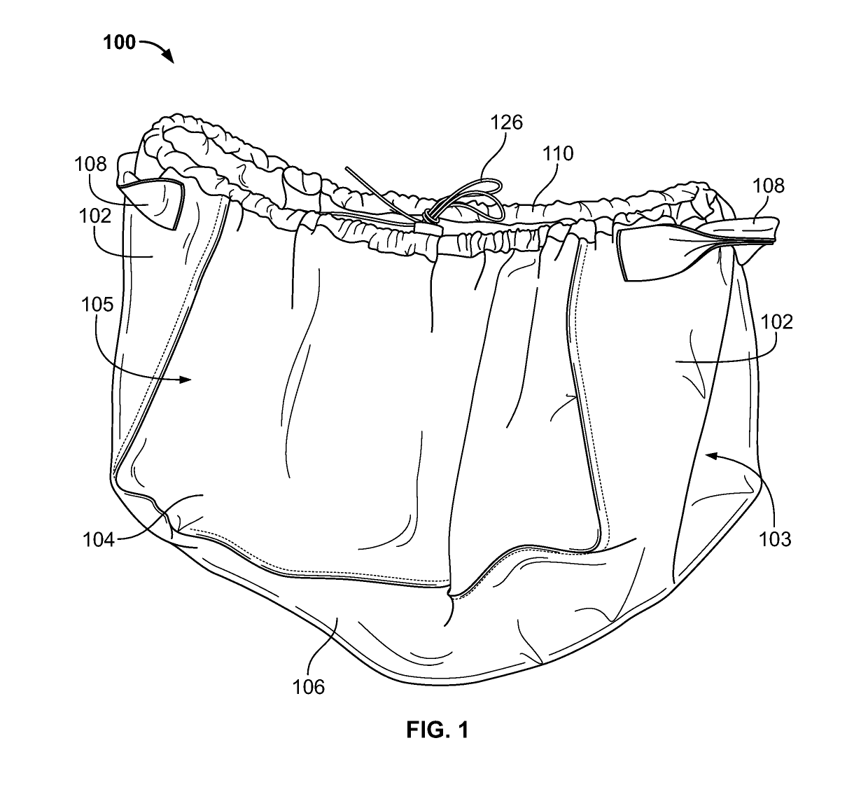

One or more embodiments of the present invention will now be described with references to FIGS. 1-8.

FIGS. 1 to 3 are illustrations of different views of the shopping bag 100 in an inside-out configuration in accordance with one or more embodiments of the present invention. As illustrated, shopping bag 100 comprises a bottom wall 106, which is preferably rectangular in shape; and a vertical portion attached to the bottom wall in a substantially perpendicular configuration to define a volume of space 120 above the bottom wall. The bottom wall is preferably made of durable and flexible fabric material. In one or more embodiments, the bottom wall is made of fabric that is durable and waterproof. Those of skill in the art would appreciate that the bottom wall may take any suitable shape without deviating from the spirit of the invention.

The vertical portion of the shopping bag 100 comprises a plurality of side walls attached to the bottom wall 106 to form the volume of space 120. The plurality of side walls are such that two side walls 102 are attached on opposing sides (e.g. left and right side) of the bottom wall 106; and two side walls 104 on the remaining and opposing sides (e.g. front side and back side) of bottom wall 106. The plurality of side walls is preferably made of durable and flexible fabric material. In one or more embodiments, the plurality of side walls is made of fabric that is durable and waterproof. Those of skill in the arts would appreciate that the side walls, i.e. 102 and 104, may be configured as one continuous piece of material attached to the bottom wall and that the bottom wall and one or more of the side walls may be one continuous piece without deviating from the spirit of the invention.

In one or more embodiments, a band 110, preferably elastic, is attached to the top edge of the side walls. The elastic band may be fixed or adjustable and provides for at least partial closure of the volume of space 120. Volume of space 120 is appropriately configured to hold retail products. The retail products may be placed in the bag while shopping and then replaced after checkout.

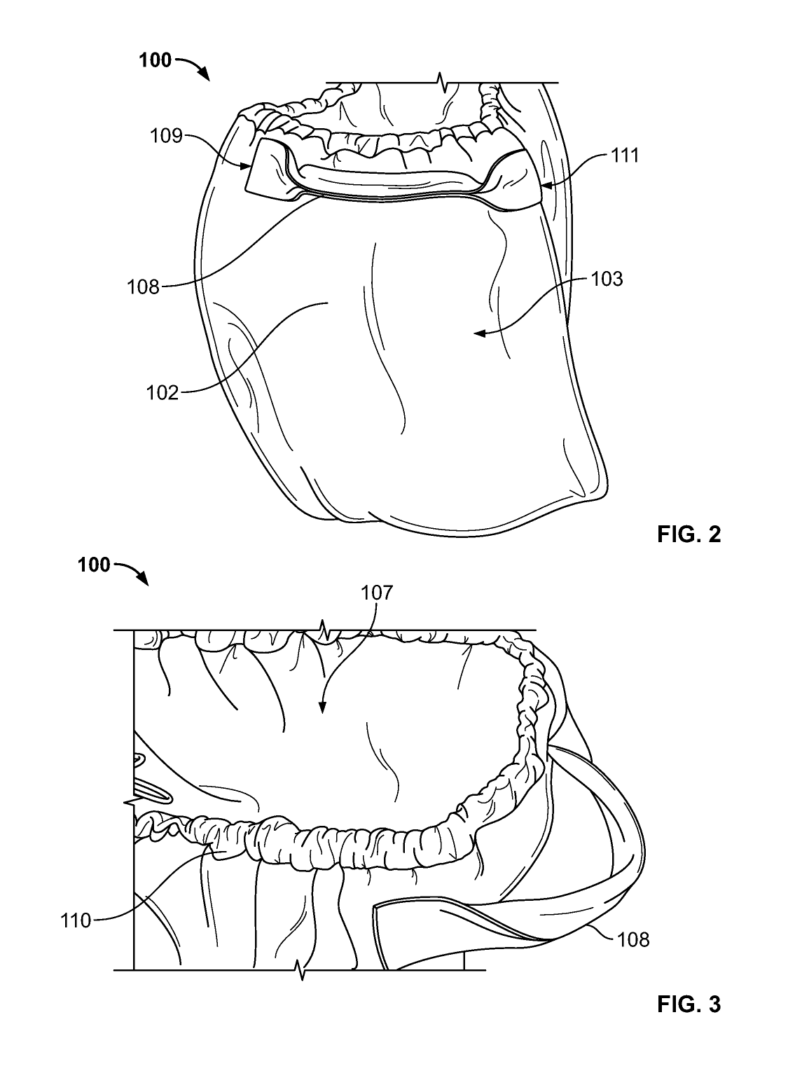

In one or more embodiments, each one of side wall 102 comprises an inside surface 103 (see FIG. 2) and an outside surface (not shown). Coupled to inside surface 103 of Side wall 102 is a handle 108. One end of handle 108 may be coupled at attachment point 109 to side wall 102, and the opposing end at attachment point 111, as shown in FIG. 3. It should be apparent to those of skill in the arts that the inside and outside surfaces of side wall 102 may be interchangeable without deviating from the scope of the invention. Handle 108 preferable comprises of durable and flexible material capable of providing support for carrying the load contained inside volume 120.

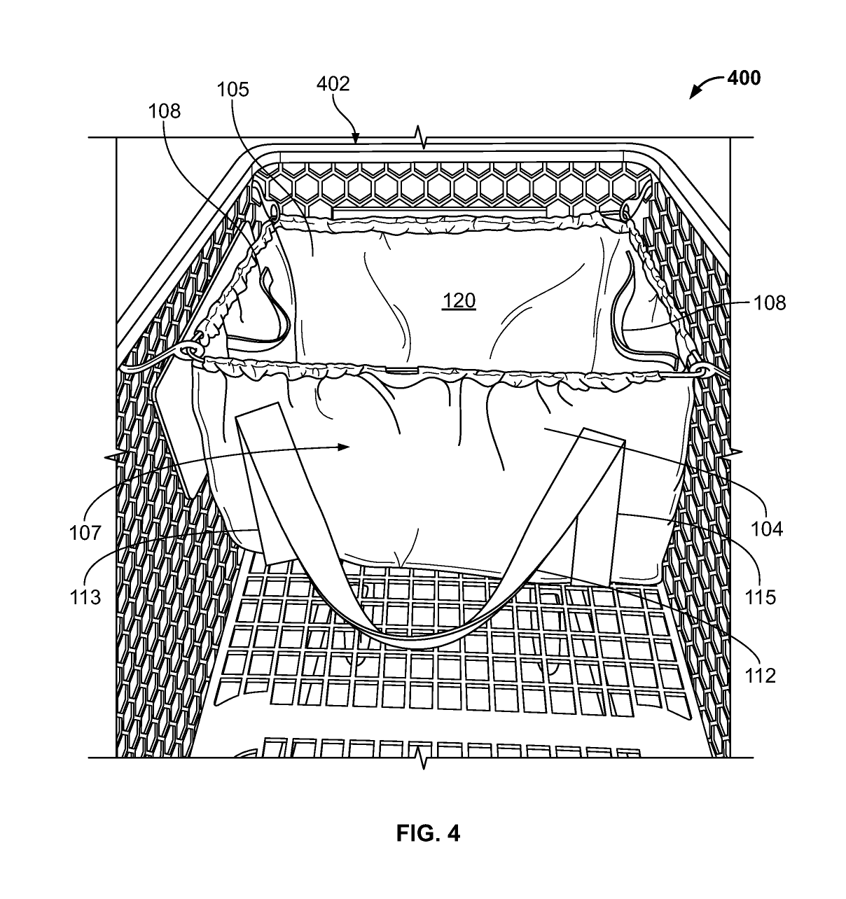

In one or more embodiments, each one of side wall 104 comprises an inside surface 105 and an outside surface 107. Coupled to outside surface 107 of Side wall 104 is a carrying strap 112. One end of carrying 112 may be coupled at attachment point 113 to side wall 104, and the opposing end at attachment point 115, as shown in FIG. 4. It should be apparent to those of skill in the arts that the inside and outside surfaces of side wall 104 may be interchangeable without deviating from the scope of the invention. Carrying strap 112 preferable comprises of durable and flexible material capable of providing support for carrying the load contained inside volume 120. Carrying strap 112 may also be a continuous piece that starts from a first side wall 104 and continues around the bottom wall to the opposing side wall 104.

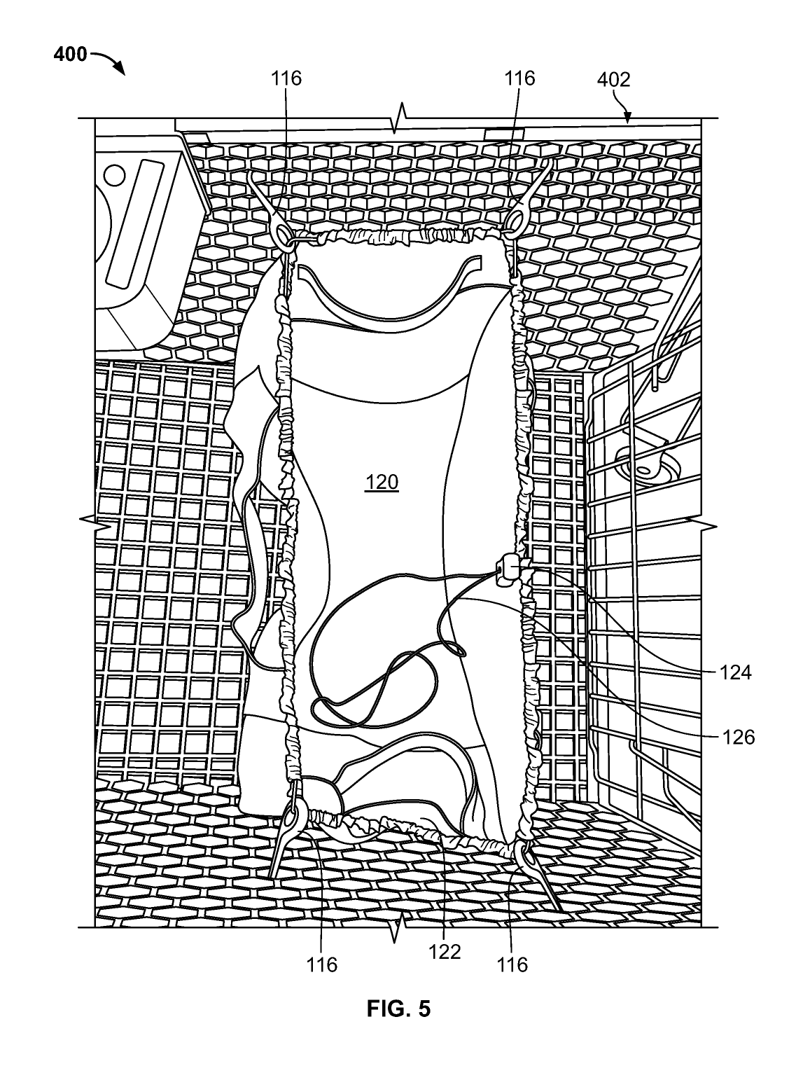

FIGS. 4 and 5 are illustrations of different views of the shopping bag 100 in a normal configuration coupled to a shopping cart 402 in accordance with one or more embodiments of the present invention. As illustrated, configuration 400 depicts the coupling of shopping bag 100 to a shopping cart 402 using a plurality of fasteners 116. At least one fastener 116 is preferable located at each corner of shopping bag 100 and coupled to band 110 and a side wall of the shopping cart 402.

As illustrated in FIG. 5, one or more compartments 122 may be included in the inside of shopping bag 100. Such compartments may be used when desired for separation of one or more items in the shopping bag. The compartments may also be useful for holding items such as cell phones, purses, etc.

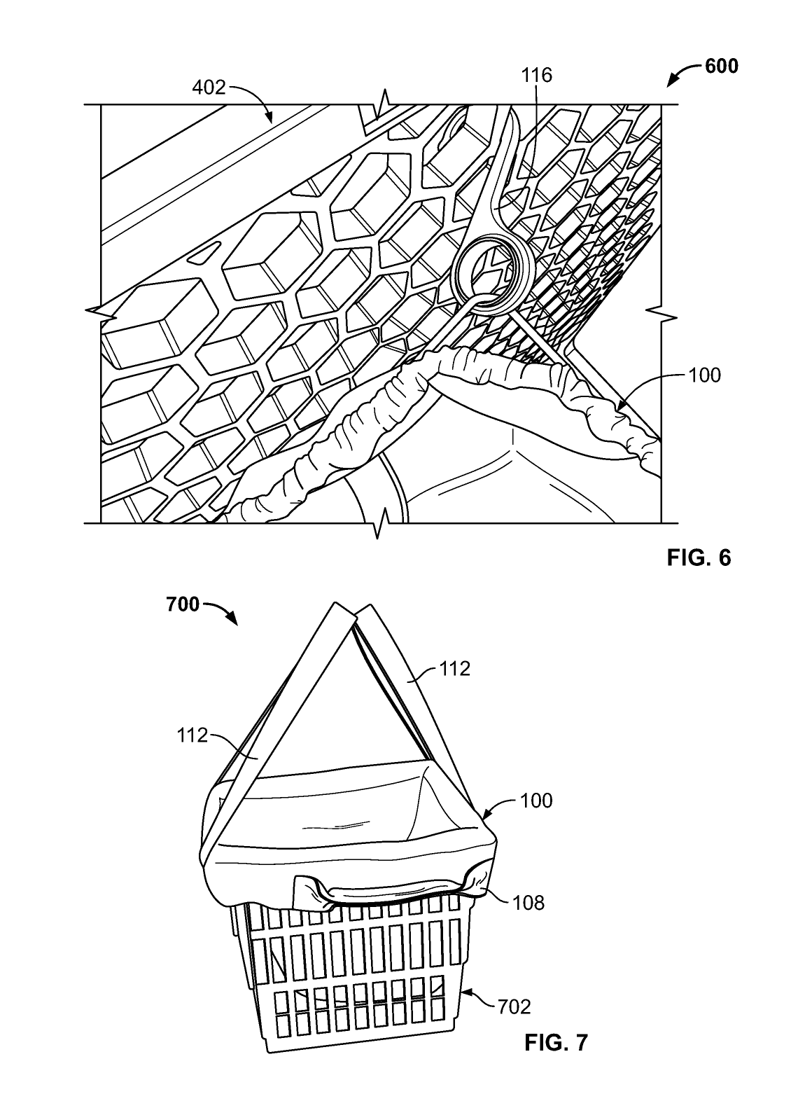

FIG. 6 is an exploded view illustrating how fastener 116 is coupled to shopping bag 100 and to shopping cart 402 in accordance with one or more embodiments of the present invention. As illustrated in 600, fastener 116 may be configured as a loop on one end and a hook on the other end, as a hook on both ends, or any other suitable configuration. The first end of fastener 116 is preferably attached to the cord (or string) 126 of shopping bag 100 while the second end is available for coupling to the side wall of shopping cart 402. Fastener 116 may be made of any durable material, e.g. plastic, metal, etc.

FIG. 7 is an illustration of the shopping bag 100 coupled to a shopping basket 702 with the shopping bag providing the handles in accordance with one or more embodiments of the present invention. As illustrated in configuration 700, shopping bag 100 may be sized appropriately to fit inside shopping basket 702. In this configuration, band 110 secures shopping bag 100 around the lip 706 of shopping basket 702 and carrying straps 112 provide support for the integrated shopping basket 702 and shopping bag 100 combination. The band 110 may be elastic or other material and may include a locking mechanism 124 and a string (or cord) 126 (see FIG. 5), which is located inside band 110 and runs the entire distance of band 110. Locking mechanism 124 and string 126 may be used for securing band 110 around the lip 706 of the shopping basket. The string 126 and locking mechanism 124 may also be used to cinch and at least partially close the bag after it has been removed from the cart or basket in order to secure the content of the bag.

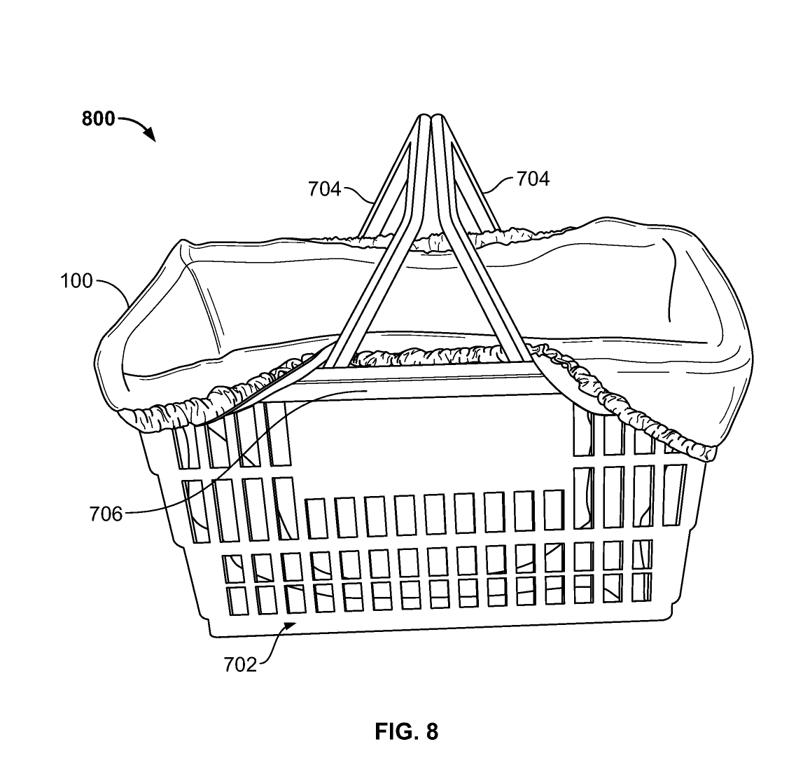

FIG. 8 is an illustration of the shopping bag 100 coupled to a shopping basket 702 with the shopping basket providing the handles in accordance with one or more embodiments of the present invention. As illustrated in 800, band 110 secures shopping bag 100 around the lip 706 of shopping basket 702 and the handles 704 of shopping basket 702 provide the support for carrying the integrated basket and the shopping bag combination.

While the invention herein disclosed has been described by means of specific embodiments and applications thereof, numerous modifications and variations could be made thereto by those skilled in the art without departing from the scope of the invention set forth in the claims.

What is claimed is:

1. A shopping bag comprising:
a bottom wall;
a vertical portion comprising a plurality of side walls attached to the bottom wall in a substantially perpendicular configuration to define a volume of space above the bottom wall and an edge at the top of the vertical portion;
a band attached to said edge at the top of the vertical portion, wherein said band is configured to secure said edge around a lip of a shopping basket;
a handle attached to each of a first one and an opposing one to said first one of said plurality of side walls;
a carrying strap attached to each of a second one and an opposing one to said second one of said plurality of side walls; and
a plurality of fasteners with at least one fastener coupled to a corner of said band, wherein each of said plurality of fasteners removably couples to a shopping cart.

2. The shopping bag of claim 1, wherein said bottom wall is rectangular.

3. The shopping bag of claim 1, wherein said bottom wall and said plurality of side walls comprise a fabric that is durable and waterproof.

4. The shopping bag of claim 1, wherein said band comprises elastic material.

5. The shopping bag of claim 1, wherein said handle comprises durable and flexible material capable of supporting any load contained inside volume of space.

6. The shopping bag of claim 1, wherein each of said plurality of fasteners comprises a hook for coupling to said shopping cart.

7. A shopping bag comprising:
a rectangular bottom wall;
a vertical portion comprising a plurality of side walls attached to the bottom wall in a substantially perpendicular configuration to define a volume of space above the bottom wall and an edge with four corners at the top of the vertical portion, wherein a first side wall is coupled to a left side of said bottom wall, wherein a second side wall is coupled to a back side of said bottom wall, wherein a third side wall is coupled to a right side of said bottom wall, and wherein a fourth side wall is coupled to a front side of said bottom wall;
a band attached to said edge at the top of the vertical portion, wherein said band is configured to secure said edge around a lip of a shopping basket;
a pair of handles attached to said first side wall and said third side wall;
a pair of carrying straps attached to said second side wall and said fourth side wall; and
a plurality of fasteners with at least one fastener coupled to each of said four corners, wherein each of said plurality of fasteners removably couples to a shopping cart.

8. The shopping bag of claim 7, wherein said bottom wall and said plurality of side walls comprise a fabric that is durable and waterproof.

9. The shopping bag of claim 7, wherein said band comprises elastic material.

10. The shopping bag of claim 7, wherein each of said pair of said handles comprises durable and flexible material capable of supporting any load contained inside volume of space.

11. The shopping bag of claim 7, wherein a first one of said pair of handles is attached to an inside surface of the first side wall and a second one of said pair of handles is attached to an inside surface of said third side wall.

12. The shopping bag of claim 7, wherein a first one of said pair of carrying straps is attached to an outside surface of the second side wall and a second one of said pair of carrying straps is attached to an outside surface of said fourth side wall.

13. The shopping bag of claim 7, wherein each one of said plurality of fasteners comprises a hook for coupling to said shopping cart.

14. A retail shopping assembly comprising:
a shopping cart; and
a shopping bag, wherein said shopping bag comprises:
a rectangular bottom wall;
a vertical portion comprising a plurality of side walls attached to the bottom wall in a substantially perpendicular configuration to define a volume of space above the bottom wall and an edge with four corners at the top of the vertical portion, wherein a first side wall is coupled to a left side of said bottom wall, wherein a second side wall is coupled to a back side of said bottom wall, wherein a third side wall is coupled to a right side of said bottom wall, and wherein a fourth side wall is coupled to a front side of said bottom wall;
a band attached to said edge at the top of the vertical portion, wherein said band is configured to secure said edge around a lip of a shopping basket;
a pair of handles attached to said first side wall and said third side wall;
a pair of carrying straps attached to said second side wall and said fourth side wall; and
a plurality of fasteners with at least one fastener coupled to each of said four corners and removably coupled to a sidewall of said shopping cart.

15. The retail shopping assembly of claim 14, wherein said bottom wall and said plurality of side walls comprise a fabric that is durable and waterproof.

16. The retail shopping assembly of claim 14, wherein said band comprises elastic material.

17. The retail shopping assembly of claim 14, wherein said handle comprises durable and flexible material capable of supporting any load contained inside volume of space.

18. The retail shopping assembly of claim 14, wherein each one of said plurality of fasteners comprises a hook.

19. The retail shopping assembly of claim 14, wherein a first one of said pair of handles is attached to an inside surface of the first side wall and a second one of said pair of handles is attached to an inside surface of said third side wall.

20. The retail shopping assembly of claim 14, wherein a first one of said pair of carrying straps is attached to an outside surface of the second side wall and a second one of said pair of carrying straps is attached to an outside surface of said fourth side wall.
